(19) United States
(12) Patent Application Publication
(10) Pub. No.: US 2008/0296127 A1
(43) Pub. Date: Dec. 4, 2008

(54) Article-Positioning Machine

(76) Inventors: Alex Marti Mercade, Sant Cugat Del (ES); Jaime Marti Sala, Barcelona (ES)

Correspondence Address: RATNERPRESTIA, P O BOX 980, VALLEY FORGE, PA, 19482-0980, US

(21) Appl. No.: 10/581,180

(22) PCT Filed: Dec. 1, 2003
(86) PCT No.: PCT/ES2003/000612

§ 371 Date: Aug. 18, 2008

(51) Int. Cl. B65G 47/14

(52) U.S. Cl. 198/396

(57) ABSTRACT

The invention relates to an article-positioning machine. The inventive machine comprises means for collecting the articles in a plurality of individual housings which move in a closed circuit and for enabling the articles to fall through at least one drop zone, each of the oriented articles being directed into a corresponding alignment conduit which moves together with each housing. The machine also comprises release means for removing the oriented and aligned articles from the alignment conduits and moving same to an outfaced conveyor. Moreover, each alignment conduit comprises an upper portion which is used to collect articles from the corresponding housing, at least one self-guided mobile middle portion which defines at least one and a lower portion which receives the articles and which comprises at least two compartments to which the article can be transferred.

### SCOPE OF THE INVENTION

In general, this present invention concerns an article-positioning machine and more specifically, an article-positioning machine comprising the means to collect articles from a plurality of individual housings that move in a closed loop and, in at least one drop zone, allow each to drop orientated to the inside of a corresponding alignment conduit that moves with each housing adapted to position more than one article during each cycle or rotation.

### BACKGROUND

Machines are habitual in various industrial sectors to position articles, which are initially disordered, in a predetermined position and aligned arrangement. Specifically, in the packaging state of the art, machines are employed to stand and order bottles or empty containers in an upright position, resting on their bases with the filling aperture at the top. Generally, said filling aperture forms a neck that constitutes a differentiated geometric configuration of the bottle or container at the end opposite to the base, in general defining an imaginary longitudinal axis between both ends.

U.S. Pat. No. 3,295,659 describes a machine based on an operating principle that has converted it into the most widely used in many types of particle-positioning machines. This principle is based on the handling of the mentioned differentiated geometric configuration for standing the articles up, and consists of first placing the articles individually in housings, in a horizontal position and with the longitudinal axis of the article pre-orientated according to the direction of said housing so that the differentiated geometric configuration faces one of the other ends of the housing; then allowing the article Z to drop through the open bottom of the housing into an alignment conduit, in the mouth of which contains stop and support configurations intended to hold said differentiated geometric configuration whatever its position relative to the housing in order for the article to always drop onto its base. To accomplish this, at least one of said stop configurations is shaped so that article Z positions itself in a different manner in the alignment conduit mouth according to said relative position of the differentiated configuration so that this is always located above one of said support configurations. The machine adopts a rotating configuration in which a plurality of said cavities intended to receive an article are radially arranged on the periphery of a circular structure.

U.S. Pat. No. 3,662,872 describes a rotating positioning machine intended for empty lightweight bottles or containers in which a series of housing are joined to a rotating structure, arranged tangentially on the periphery of the same, around a container that receives the articles in a disordered fashion and which is fitted with the means to load a container or bottle into each housing in a horizontal position, with its longitudinal axis pre-orientated in accordance with the tangential direction of the housing and with the neck at the front or rear part with respect to the rotation direction. Each of the cited housings has an open bottom on an alignment conduit with moves with the same. Interposed between the open housing bottoms and the respective alignment conduits is a stationary support plane, which presents two interruptions in two opposite sections of the rotating path through the interruptions of which the articles drop by gravity into the alignment conduit. In determined zones of said housings are the cited stops and supports intended to support said neck when the container falls inside the alignment conduit via the cited interruption in the support plane, so that the container is always in a vertical position inside the alignment conduit, with the neck at the top and the base at the bottom. Some means of deflection finally transfer the containers orientated in a vertical position from the alignment conduits to an output conveyor belt. This machine also includes a partition that vertically divides a lower zone of each alignment conduit into two equal compartments, together with a deflector plate arranged articulating with an upper end of said partition and driven by drive means to alternately change the position so that articles drop towards one or the other of said compartments. With this, the machine is able to load two articles in each alignment conduit via the same peripheral housing during one rotation.

U.S. Pat. No. 6,098,781 describes an empty container positioning machine of the type described above in which the stationary support plane has various interruptions. Each housing has a corresponding upper portion of an alignment conduit that moves together with the same. Underneath the upper alignment conduit portions is a plurality of lower alignment conduit portions in a plurality that is a multiple of the plurality of upper portions and said lower portions move at a peripheral speed that is greater than the speed at which the housing and upper portions move, so that, during one rotation, several lower portions consecutively face each upper portion coinciding with one of the cited support plane interruptions. This device allows more than one container to be aligned by each housing during one rotation. However, it has the inconvenience of the relative movement between the upper and lower portions being continuous and the useful mutual facing time to allow the container to pass coinciding with one of the support plane interruptions is extremely short, which could lead to incorrect operation.

In addition to this, in the above-described rotating positing machines, the entrance housing and alignment conduit compartments have fixed dimensions suitable for articles of just one size. In order to adapt the machine to articles of various sizes, it would be necessary to replace the said housings and alignment conduits, among other elements, which would represent a high cost in time for the replacement operation, higher investment in manufacturing the alternative elements, together with higher storage costs for said elements.

U.S. Pat. No. 6,435,333 to the current applicant describes a rotating machine that obeys the same principle, although with a single interruption in the support plane and a single space inside the alignment conduit. However, this machine is adapted to adjust to the handling of bottles or containers of several sizes through the incorporation of the means to move the stops and supports located in the housings and intended for supporting the container neck when it falls into the alignment conduit, as well as to move side walls of the alignment conduit and other elements intended for adjusting the machine to articles of various sizes. All these moving elements for the housings and alignment conduits are moved at the same time by an angular movement relative to a circular, coaxial substructure to which said moving elements are fixed.

One objective of the present invention is that of providing an article-positioning machine based on the cited principle of allowing the articles drop into alignment conduits, capable of positioning more than one article in each alignment conduit during one revolution or cycle.

Another objective of the present invention is that such a machine includes the means to adjust the housings and alignment conduit to articles of various sizes.

### DISCLOSURE OF THE INVENTION

In accordance with the present invention, the previous and other objectives are achieved, producing an article-positioning machine of the type comprising the means to collect the articles in a plurality of individual housings that move in a closed circuit and, in at least one drop zone, allows the orientated articles to drop inside a corresponding alignment conduit that moves together with each housing and the means of exit to extract the orientated and aligned articles from the said conduits onto an exit conveyor belt. The machine is characterised in that each alignment conduit comprises an upper portion for collecting the articles from the corresponding housing, at least one moving intermediate portion defining at least one conduit, and a lower portion for receiving the articles comprising at least two compartments, with a stationary support plane interposed between the intermediate and lower portions, with drive means incorporated to selectively move said intermediate portion in order to face said conduit to the upper portion and receive an article from the same, and/or face the conduit to one or other said at least two compartments of the lower portion to transfer said article through at least one interruption existing in said support plane.

In general, said closed circuit is circular or elliptical and it comprises two or more drop zones along the same, with an equal plurality of compartments in the lower portion of each alignment conduit. Thanks to this, the machine is capable of positioning two or more articles in each alignment conduit during each rotation or cycle, which provides higher productivity.

The machine of this invention can incorporate any of the known systems to orientate the articles, with some of said systems described in the above cited patents. In general, although not essential, the articles have a body with a differentiated configuration and a base, and the system uses an interaction with the said differentiated configuration to stand the article up on its base. In a specific application, the articles are empty lightweight containers and the differentiated configuration is a neck next to an aperture, and the machine is adapted to stand up and align the initially disordered and in bulk containers into the cited exit conveyor belt.

The machine of this invention can also incorporate any of the known mechanisms to adjust the size of the cavities and alignment conduits to articles of various sizes, for example, a system of moving parts, such as the one described in above-cited U.S. Pat. 6,435,333.

### A BRIEF DESCRIPTION OF THE DRAWINGS

The advantages and characteristics of the invention will be more fully understood from the following detailed description of exemplary embodiments, with reference to the attached drawings, in which:

FIG. 1 is a perspective schematic view illustrating a generally circular arrangement of the alignment conduits in an article-positioning machine in accordance with the present invention;

FIG. 2 is a schematic drawing representing a linear development of the circular arrangement of the alignment conduits of FIG. 1 with different articles represented in order to illustrate different stages during one rotation or cycle;

FIGS. 3 and 4 are enlargements of the schematic diagram shown in FIG. 2;

FIGS. 5 and 6 are schematic rear elevation views of a housing and part of its corresponding alignment conduit, showing the drive means of the upper portion and two different possible positions of same;

FIGS. 7 and 8 are schematic elevation views of a housing and its corresponding alignment conduit, showing the means to adapt the housing, the upper and lower portions to articles of various sizes in two different positions;

FIGS. 9 and 10 are perspective schematic views that show the means to adapt the bottoms of the lower portion to articles of various sizes in two different positions;

FIGS. 11 and 12 are schematic cross-sectional views taken along an alignment conduit that show the means to adapt the housing bottoms and of the upper intermediate and lower portions to articles of various sizes in two different positions.

### DETAILED DESCRIPTIONS OF SOME EMBODIMENT EXAMPLES

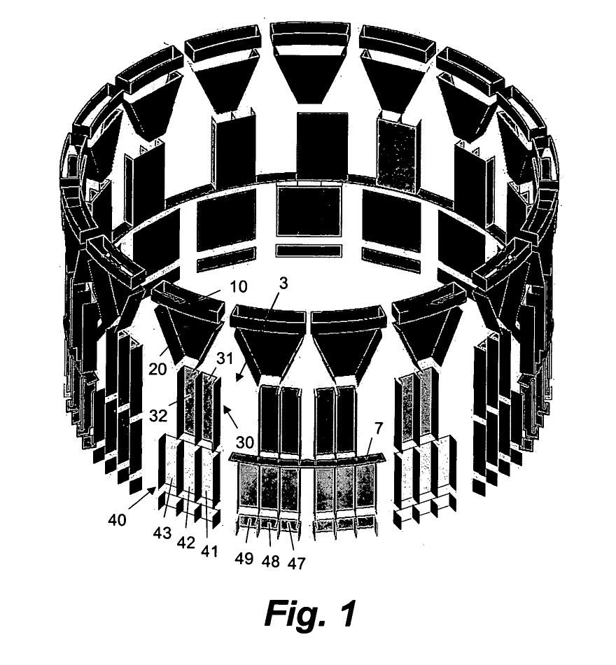

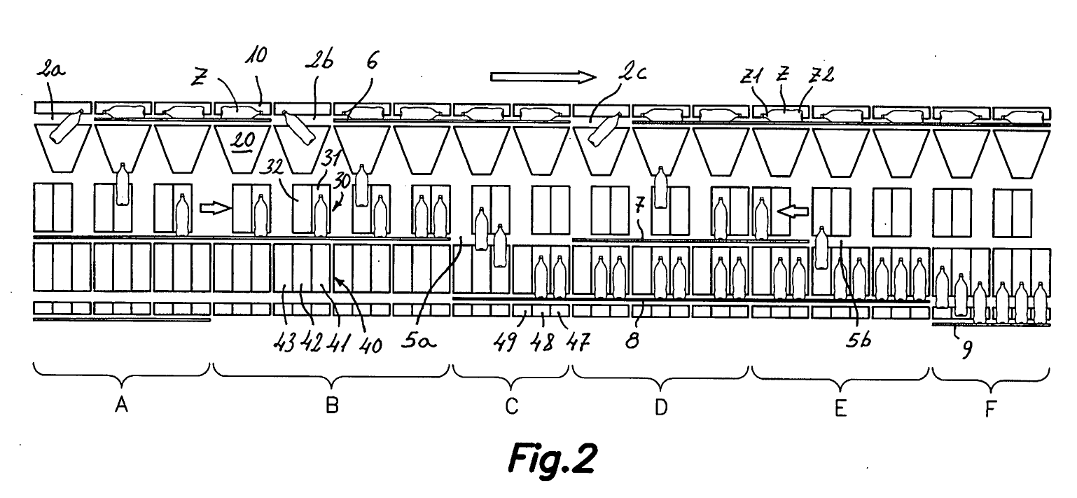

First referring to FIG. 1, this schematically shows a possible configuration for a machine in accordance with the present invention adapted for positioning articles Z in the form of empty lightweight containers (see FIGS. 2 to 4) with a differentiated configuration Z1, or neck, at one end and a base Z2 at the other end, with an imaginary longitudinal axis defined between both ends. In an illustrated example, the machine has a circular configuration and comprises a fixed frame, a rotating structure and a surrounding exterior wall (not shown). In an upper peripheral zone of the rotating structure, a plurality of individual housings 10 are arranged; each one adapted to receive an article Z in a horizontal arrangement and with its longitudinal axis pre-orientated in accordance with the tangential direction the cited housing. A corresponding alignment conduit 3 is arranged underneath each housing 10 and fixed to the rotating structure, so that each alignment conduit 3 is moved together with its housing 10. Each alignment conduit 3 comprises an upper portion 20 for collecting articles Z from the corresponding housing 10, at least one intermediate moving position 30, defining a pair of conduits 31, 32 and a lower portion 40 for receiving articles Z comprising three compartments 41, 42, 43. The upper 20, intermediate 30 and lower 40 portions comprising the alignment conduits 3 have open exterior parts that are delimited by the mentioned surrounding exterior wall (not shown), which is stationary. The machine includes well-known exit means (not shown) to extract the orientated and aligned articles Z from said alignment conduits 3 onto an exit conveyor belt.

Between the housings 10 and the upper portions 20 is a separation space containing a first support plane 6 on which the articles Z are supported and slide and move inside each housing. In drop zones 2, the first support plane 6 is interrupted to allow the articles Z drop inside the corresponding upper portion 20, which has a funnel shape with an upper aperture of suitable width for the longitudinal dimension of article Z and a lower aperture of width suitable for the transversal dimension of the article Z. The intermediate portion 30 is connected to drive means 4 which are activated to selectively move said intermediate portion 30 in order to face an upper aperture of one or the other conduits 31, 32 to the lower aperture of the upper portion 20 in order to receive an article Z from same. The intermediate 30 and lower 40 portions are separate and between the same a second stationary support plane 7 is interposed on which the articles Z are supported and slide and move inside each conduit 31, 32. The cited drive means 4 can also be activated to move the intermediate portion 30 to face the lower apertures of the two conduits 31, 32 to upper apertures of two of the three compartments 41, 42, 43 of the lower portion 40 in order to transfer the article Z or articles Z from the conduits 31, 32 to the compartments 41, 42, 43 through interruptions 5a, 5b existing in said second support plane 7. Underneath the lower apertures of the compartments 41, 42, 43 is a third stationary support plane 8 on which the articles Z are supported and slide inside compartments 41, 42, 43.

Although not essential, the compartments 41, 42, 43 preferably have lower supplements 47, 48, 49 located under the third support plane 8 and above an additional fourth stationary support plane 9, on which the articles Z are supported and slide inside compartments 41, 42, 43, after which the same have descended through an interruption in the third support plane 8. The mentioned exit means (not shown) extract the orientated and aligned articles Z from said lower supplements 47, 48, 49 of the compartments 41, 42, 43 onto the cited exit conveyor belt.

In the illustrated exemplary embodiment, the selective movement of each intermediate portion 30 is transversal to the direction of drop of the articles Z along the alignment conduit 3 and comprises a return movement with stops at the ends of travel and without intermediate stops. Each stop determines the cited facing of the conduits 31, 32 with the upper portion 20 and the facing of the compartments 41, 42, 43. The second support plane 7 comprises at least two interruptions 5a, 5b because, just as explained in detail below, the filling of the three compartments 41, 42, 43 of each intermediate portion 30 is performed in two stages.

It is pointed out that the drive means 4 could be adapted to provide one or more intermediate stops in addition to the ends of travel of the cited return movement, so that an intermediate portion 30 with a single conduit could distribute articles to a lower portion 40 with three or more compartments, or an intermediate portion 30 with three or more conduits could distribute articles to a lower portion 40 with four or more compartments etc. In this case, the second support plane 7 would comprise multiple interruptions to fill the compartments in multiple stages. It must be taken into account however, that the plurality of compartments existing in each lower portion 40 is logically limited by the ratio between the longitudinal and transversal dimensions of the article Z and by the plurality of housings 10 and alignment conduits 3 existing in the length of the closed circuit. In any case, the closed circuit comprises as many drop zones 2, in other words, interruptions in the first support plane 6 associated with the housings 10, as compartments 41, 42, 43 in the lower portion 40.

In accordance with an exemplary embodiment that is not shown, the intermediate portion 30 defines a single conduit and articulates with the lower end of the upper portion 20. The drive means 4 provide, in this case, the pendular movement of the intermediate portion 30 with stops at, at least the ends of travel, with each stop determined by one of the cited facings of the lower aperture of the conduit with the upper aperture of one of the compartments 41, 42, 43, while constantly maintaining the facing of the upper aperture of the conduit of the intermediate portion 30 with the lower aperture of the upper portion 20.

In relation to FIGS. 2 to 4, the procedure followed to load the three compartments 41, 42, 43 during one rotation or cycle is explained below. FIG. 2 schematically shows a linear development of the 17 housings 10 with their corresponding alignment conduits 3, which are fixed to the rotating structure of the machine as suggested by the circular layout of FIG. 1, and the rotating structure rotates in the direction indicated by an arrow 50 in FIGS. 2 to 4.

In a first stage A, an article Z moving inside a housing 10 drops through a first interruption 2a of the first support plane 6 into an upper potion 20 to continue inside a first conduit 31 of the intermediate portion 30 facing, at this time, the upper portion 20. The article Z is moved together with the first conduit 31, supported on and sliding over the second support plane 7.

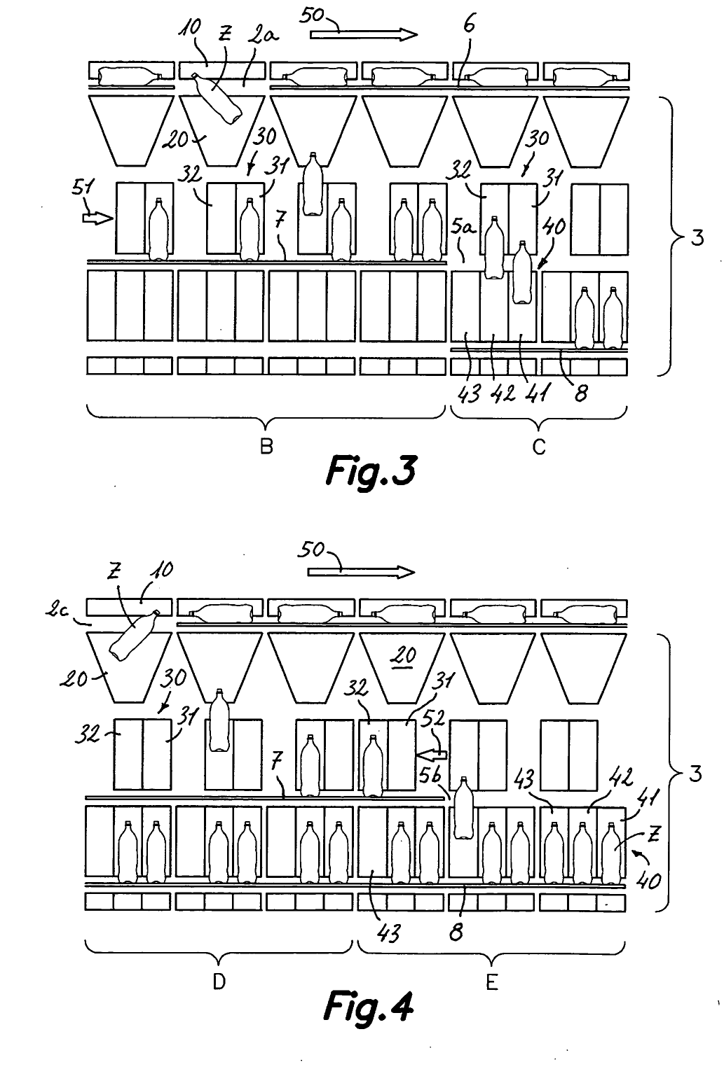

In a second stage B, better shown in FIG. 3, the drive means 4 move the intermediate portion 30 in the direction indicated by an arrow 51 to face the second conduit 32 of the intermediate portion to the upper portion 20, followed by another article Z dropping through a second interruption 2b of the first support plane 6 and through the upper portion 20 into the second conduit 32 of the intermediate portion 30. Thus, two articles Z are respectively moving with the first and second conduits 31, 32 supported on and sliding over the second support plane 7.

In a subsequent stage C, better shown in FIG. 3, a first interruption 5a in the second support plane 7 causes the transfer, by gravity, of the two articles Z from the first and second conduits 31, 32 of the intermediate portion 30 to first and second compartments 41, 42 of the lower portion 40 facing at that point the first and second conduits 31, 32. Thus, the two articles Z are respectively moving with the first and second compartments 41, 42 supported on and sliding over the third support plane 8. Now, the first and second conduits 31, 32 of the intermediate portion 30 and the third compartment 43 of the lower portion 40 are unoccupied.

Then, in a stage D, better shown in FIG. 4, an article Z moving inside a housing 10 drops through a third interruption 2c of the first support plane 6 and through an upper portion 20 inside the second conduit 31 of the intermediate portion 30, which, at this moment is facing the upper portion 20. The article Z is moved together with the second conduit 32, supported and sliding on the second support plane 7.

In a subsequent stage E, better shown in FIG. 4, the drive means 4 move the intermediate portion 30 in the direction indicated by an arrow 52 to face the second conduit 32 of the intermediate portion 30, which contains an article Z, with the still unoccupied third compartment 43, of the lower portion 40 and then, the article Z drops from the second conduit 32 to the third compartment 43 through a second interruption 5b of the second support plane 7, so that the three compartments 41, 42, 43 of the lower portion 40 are loaded with respective articles Z during one revolution. The three articles Z move together with the three compartments 41, 42, 43 supported on and sliding over the third support plane 8.

In an optional stage F, better shown in FIG. 2, the three articles Z are transferred by gravity from the three compartments 41, 42, 43 to the mentioned lower supplements 47, 48, 49 through an interruption of the third support plane 8 to be moved inside the lower supplements 47, 48, 49 supported on and sliding over the stationary fourth support plane 9, from which the exit means (not shown) extract the orientated and aligned articles Z from said lower supplements 47, 48, 49 of the compartments 41, 42, 43 onto the cited exit conveyor belt.

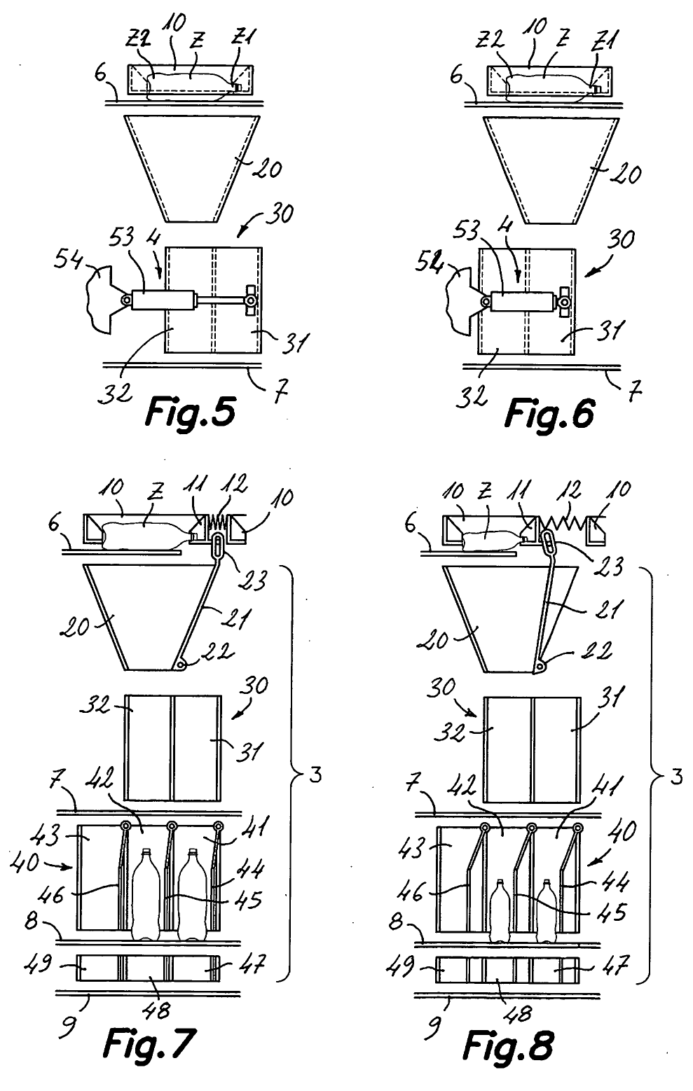

FIGS. 5 and 6 show the drive means 4, which, in the illustrated exemplary embodiment, comprise at least one fluidodynamic cylinder 53 connected at one end to a rear part of the intermediate portion 30 and by the other end to a part 54 of the rotating structure. Control means are adapted to independently control the fluidodynamic cylinder 53 associated with each intermediate portion 30 in order to produce the movements of the same in accordance with the above-described stages. In FIG. 5, the fluidodynamic cylinder 53 has extended its spindle to face the upper aperture of the second conduit 32 to the lower aperture of the upper portion 20 (see the description of stage B with reference to FIG. 3). In FIG. 6, the fluidodynamic cylinder 53 has retracted its spindle to face the upper aperture of the first conduit 31 to the lower aperture of the upper portion 20 (see the description of stage E with reference to FIG. 4).

However, although not illustrated, other drive means are possible. For example, when a rocking movement is required with intermediate stops, the drive means can comprise a set of two or more fluidodynamic cylinders associated with each intermediate portion 30 and the control means can control each of the fluidodynamic cylinders in the set independently of the fluidodynamic cylinders in the other sets associated with the other intermediate portions 30. In any construction employing one or more fluidodynamic cylinders, it may be advantageous to also use a mechanical movement transmission for each intermediate portion 30 for available space conditions. It would also be possible to eventually provide the drive means in the form of at least one electric motor, with a mechanical movement transmission associated with each intermediate portion 30. This electric motor would be independently controlled by the control means to produce the cited rocking movement with or without intermediate stops.

In another exemplary embodiment, said drive means for the intermediate portions comprise at least one stationary cam profile, fixed to a machine bed and at least one cam follower associated with each intermediate portion 30. The cam follower has a configuration adapted to force, via the cam follower, the intermediate portion 30 to make the required movements in accordance with the positions of the interruptions of the support planes etc.

In relation to FIGS. 7 and 8, the means to adapt the machine to articles Z of various sizes are described. Thus, the housings 10 and their corresponding upper access portions 20 comprise at least respective lateral moving parts 11, 21, coupled together and susceptible to be changed in position to adapt the housings 10 and upper portions 20 to articles Z of different sizes. The lateral moving part 11 of housing 10 is mounted in such a way that it can be forced to make movements to enlarge or reduce the longitudinal dimension of housing 10. The lateral moving part 21 of the upper portion 20 is articulated at its lower end 22 and is moved by its coupling by means of a sliding articulation 23 with respect to the lateral moving part 11 of housing 10. A bellows 12 is fitted to cover a separation space created by the movement of the lateral moving part 11 of the housing 10 with respect to the adjacent housing 10.

The lower portions 40 comprise at least one lateral moving part 44, 45, 46 associated with each compartment 41, 42, 43. Each lateral moving part 44, 45, 46 preferably comprises a wall that moves parallel to the walls of the respective compartment 41, 42, 43 and an articulated tilting part by the upper end and coupled by the lower end to its corresponding parallel movement wall. In the case in which the lower supplements 47, 48, 49 of the compartments 41, 42, 43 are present, said lateral moving parts 44, 45, 46 also preferably have corresponding supplements to the same. The lateral moving parts 44, 45, 46 are susceptible to changing position to adapt the lower portions 40 to articles Z of various sizes. If considered necessary, the intermediate portions 30 can also have equivalent moving parts (not shown) associated with the conduits 31, 32. Advantageously, all lateral moving parts 11, 21, 44, 45, 46 associated with all the housings 10, upper portions 20 and lower portions 40 can be moved at the same time by a simple manually operated mechanism that includes, for example, one or more rotating rings along the length of the machine to which mechanisms associated with the various moving parts are connected.

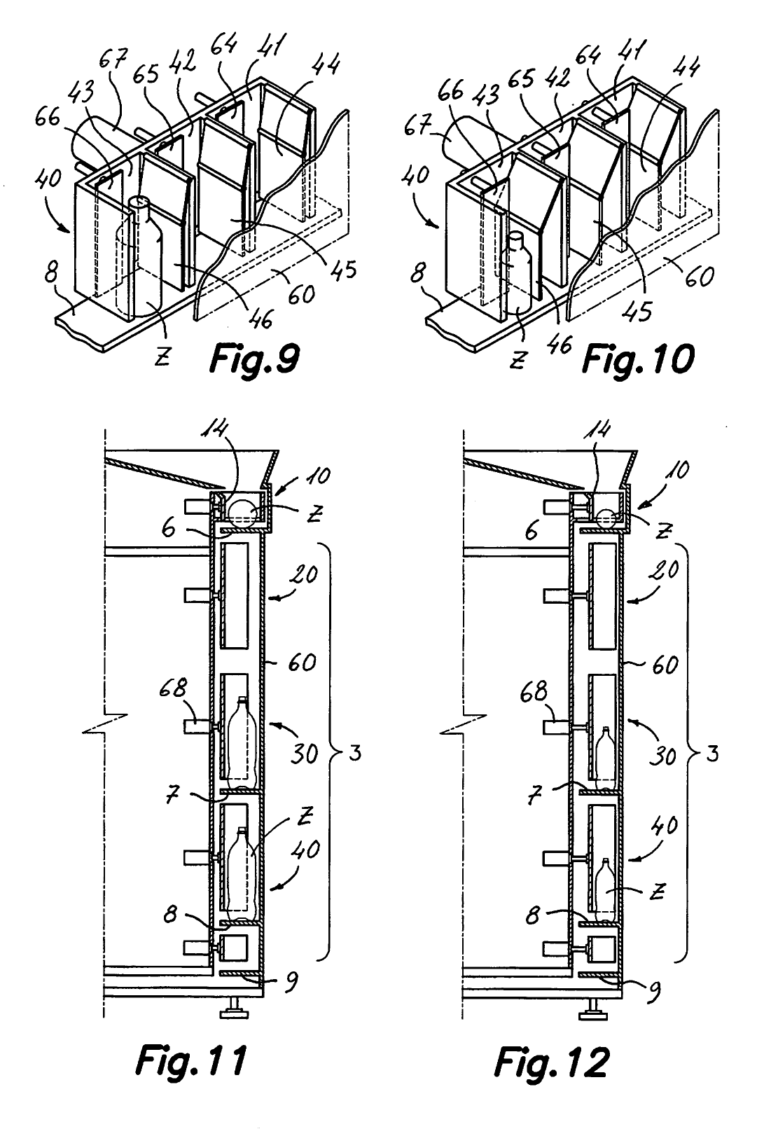

FIGS. 9 and 10 show an embodiment variant in which the lower portions 40 also comprise at least one interior moving part 64, 65, 66 associated with each compartment 41, 42, 43, with said interior moving parts 64, 65, 66 susceptible to being changed in position to adapt the lower portions 40 to the articles Z of various sizes. The mentioned position change can be manually performed or by a drive device, such as a fluidodynamic cylinder 67.

The interior moving parts 64, 65, 66 can have a reduced width in order not to interfere with the mentioned lateral moving parts 44, 45, 46.

FIGS. 11 and 12 show another embodiment variant in which the housings 10 have corresponding interior moving parts 14, similar to those described in relation to FIGS. 9 and 10, and upper portions 20, intermediate portions 30 and lower portions 40 form respective moving assemblies susceptible to being changed in position to adapt to articles Z of various sizes. The lateral walls of said moving assemblies have reduced depth to allow the movement of the assemblies without interfering with an external static enclosure wall 60. The movement of the assemblies of the upper portions 20, intermediate portions 30 and lower portions 40 can be performed manually and individually or jointly, for example by a cam mechanism, or can be performed by one or more drive devices, such as fluidodynamic cylinders 68.

Although the present invention has been described and illustrated by means of specific exemplary embodiments, the scope of the invention is not limited to the same, but instead is defined by the attached claims.

1. An article-positioning machine of the type comprising the means to collect the articles in a plurality of individual housings moving in a closed circuit and, in at least one drop zone allow the orientated articles to each drop inside a corresponding alignment conduit moved together with each housing and exit means to extract the orientated and aligned articles from said alignment conduits onto an exit conveyor belt, each alignment conduit comprising an upper portion for article collection from the corresponding housing, at least one moving intermediate portion defining at least one conduit and a lower portion for receiving the articles comprising at least two compartments existing in a stationary support plane interposed between the intermediate and lower portions, incorporating drive means to selectively move said intermediate portion in order to face said conduit with the upper portion and receive an article from the same, and/or face the conduit with one or other said at least two compartments of the lower portion to transfer said article to the same via at least one interruption existing in said support plane.

2. A machine in accordance with claim 1, wherein said selective movement of the intermediate portion is transversal to the drop direction of the articles along the alignment conduit.

3. A machine in accordance with claim 2, wherein said selective movement of the intermediate portion is a return movement with stops at the ends of travel and without intermediate stops, each stop determining at least one of the cited facings of cited at least one conduit.

4. A machine in accordance with claim 3, wherein said intermediate portion comprises two adjacent conduits, said lower portion comprises three adjacent compartments and the support plane comprises at least two interruptions.

5. A machine in accordance with claim 2, wherein said selective movement of the intermediate portion is a return movement with stops at the ends of travel and at least one intermediate stop, each stop determining at least one of the cited facings of at least one conduit.

6. A machine in accordance with claim 5, wherein said intermediate portion comprises three adjacent conduits and said lower portion comprises four or five adjacent compartments and the support plane comprises at least two interruptions.

7. A machine in accordance with claim 1, wherein said intermediate portion defines a single conduit and articulates with the lower end of the upper portion, with said selective movement of the intermediate portion pendular with stops at, at least the ends of travel, each stop determining at least one of the cited facings of the conduit with one of the compartments while constantly maintaining the cited facing with the upper portion.

8. A machine in accordance with claim 1, wherein said closed circuit is circular or elliptical and comprises as many drop zones as there are compartments in the lower portion.

9. A machine in accordance with claim 2, wherein said drive means comprises at least one fluidodynamic cylinder associated with each intermediate portion and independently controlled by control means.

10. A machine in accordance with claim 5, wherein said drive means comprises at least one set of two fluidodynamic cylinders associated with each intermediate portion and independently controlled by control means.

11. A machine in accordance with claim 9, wherein said drive means also comprises a mechanical movement transmission for each intermediate portion.

12. A machine in accordance with claim 2, wherein said drive means comprises at least one electric motor associated with each intermediate portion and independently controlled by control means.

13. A machine in accordance with claim 2, wherein said drive means comprises at least one electric motor and a mechanical movement transmission associated with each intermediate portion with said electric motor independently controlled by control means.

14. A machine in accordance with claim 2, wherein said drive means comprises at least one stationary cam profile fixed to a machine bed and at least one cam follower associated with each intermediate portion.

15. A machine in accordance with claim 1, wherein said housings are adapted to collect the articles in a horizontal and pre-orientated position.

16. A machine in accordance with claim 1, wherein said housings and their corresponding upper access portions comprise respective lateral moving parts coupled together and susceptible to being changed position to adapt the housings and upper portions to articles of different sizes.

17. A machine in accordance with claim 16, wherein said housings and/or their corresponding upper portions also comprise respective interior moving parts susceptible to being changed position to adapt the housings and upper portions to articles of different sizes.

18. A machine in accordance with claim 1, wherein said lower portions comprise at least one lateral moving part associated with each compartment, with said lateral moving part susceptible to being changed position to adapt the lower portions to articles of different sizes.

19. A machine in accordance with claim 18, wherein said lower portions also comprise at least one interior moving part associated with each compartment, with said lateral moving parts susceptible to being changed position to adapt the lower portions to articles of different sizes.

20. A machine in accordance with claim 1, wherein said upper portions and/or intermediate portions and/or lower portions form respective moving assemblies susceptible to being changed position to adapt the upper (and/or intermediate and/or lower portions to articles of different sizes.

21. A machine in accordance with claim 2, wherein said closed circuit is circular or elliptical and comprises as many drop zones as there are compartments in the lower portion.

22. A machine in accordance with claim 3, wherein said closed circuit is circular or elliptical and comprises as many drop zones as there are compartments in the lower portion.

23. A machine in accordance with claim 4, wherein said closed circuit is circular or elliptical and comprises as many drop zones as there are compartments in the lower portion.

24. A machine in accordance with claim 5, wherein said closed circuit is circular or elliptical and comprises as many drop zones as there are compartments in the lower portion.

25. A machine in accordance with claim 6, wherein said closed circuit is circular or elliptical and comprises as many drop zones as there are compartments in the lower portion.

26. A machine in accordance with claim 7, wherein said closed circuit is circular or elliptical and comprises as many drop zones as there are compartments in the lower portion.

27. A machine in accordance with claim 10, wherein said drive means also comprises a mechanical movement transmission for each intermediate portion.

28. A machine in accordance with claim 5, wherein said drive means comprises at least one electric motor associated with each intermediate portion and independently controlled by control means.

29. A machine in accordance with claim 5, wherein said drive means comprises at least one electric motor and a mechanical movement transmission associated with each intermediate portion with said electric motor independently controlled by control means.
